(19) United States
(12) Patent Application Publication
(10) Pub. No.: US 2019/0286062 A1
(43) Pub. Date: Sep. 19, 2019

(54) HAND POSITION CONTROL DEVICE, TIMEPIECE, AND HAND POSITION CONTROL METHOD

(71) Applicant: Seiko Instruments Inc., Chiba-shi (JP)

(72) Inventors: Kosuke YAMAMOTO, Chiba-shi (JP); Osamu Hirano, Chiba-shi (JP)

(21) Appl. No.: 16/298,275

(22) Filed: Mar. 11, 2019

(30) Foreign Application Priority Data
Mar. 14, 2018 (JP) 2018-046709

(51) Int. Cl. G04C 3/00; G04C 3/16; G04C 3/10; G04C 9/08

(52) U.S. Cl. CPC G04C 3/002; G04C 3/165; G04C 9/08; G04C 3/107; G04C 3/108

(57) ABSTRACT

A hand position control device includes a mode switching unit that is capable of switching between a normal hand movement mode and a manual hand position setting mode and a control unit that sets a pulse width of a driving pulse to be output to a coil of a motor that rotates a hand and sets a manual pulse width of the driving pulse in the manual hand position setting mode to be larger than a normal pulse width of the driving pulse in the normal hand movement mode.

### RELATED APPLICATIONS

This application claims priority under 35 U.S.C. § 119 to Japanese Patent Application No. 2018-046709 filed on Mar. 14, 2018, the entire content of which is hereby incorporated by reference.

### BACKGROUND OF THE INVENTION

### 1. Field of the Invention

The present disclosure relates to a hand position control device, a timepiece, and a hand position control method.

### 2. Description of the Related Art

In an analog timepiece, a hand is rotated through a train wheel by driving a motor. In such a timepiece, a position of the hand may be deviated, for example, due to an impact or the like. In such a case, a user adjusts the position of the hand by operating a crown, a push button or the like of the timepiece. In positional alignment of the hands, a central processing unit (CPU) moves the hand one step at a time based on the operation of the user (see, for example, JP-A-2014-119405).

A motor used for the analog timepiece is, for example, a stepping motor, and is configured to include a stator, a rotor, a coil, and the like. A pinion is provided on the rotor. The pinion is meshed with a wheel gear. A hand wheel is attached to the hand. The wheel gear is meshed with the hand wheel. The rotor rotates 180 degrees for one step, but the rotor is driven to stop at the position of 180 degrees after overrunning beyond 180 degrees. Also, backlash exists between the wheel gears. For that reason, for example, when the hand is a second hand, the second hand rotates 6 degrees in one step. However, at the time of rotation of one step of the hand, there are cases where the second hand is rotated 8 degrees instead of 6 degrees due to overrun of the rotor, the backlash between the wheel gears, and the like. Such rotational deviation of the hand becomes larger as moment of the hand increases. As such, even if the rotation of one step is too large, since a polarity of a driving signal of a second step is reversed, the hand is stopped at a proper position by driving in the second step. As an example, in a case where the hand is rotated 9 degrees by driving in the first step, the hand is rotated 3 degrees by driving in the second step.

However, in the technology described in JP-A-2014-119405, in the positional alignment of the hand, there is a case where the hand is visually recognized as being too rotated due to uneven movement of the hand or a case where the hand is visually recognized as not being rotated. As a result, in a case where the user instructs an operation of the hand while visually recognizing the movement of the hand, there is a case where it is difficult for the user to align the position of the hand.

### SUMMARY OF THE INVENTION

In view of the problems described above, each of embodiments of the invention provides a hand position control device, a timepiece, and a hand position control method that enable a hand to operate as intended by a user while suppressing electric power necessary for driving the hand in a case where the user instructs an operation of the hand while visually recognizing the movement of the hand.

A hand position control device 100 or 100A according to an embodiment of the invention includes a mode switching unit 13 or 13A that is capable of switching between a normal hand movement mode and a manual hand position setting mode and a control unit 14 or 14A that sets a pulse width of a driving pulse to be output to a coil 209 of a motor 20 that rotates a hand and sets a manual pulse width of the driving pulse in the manual hand position setting mode to be larger than a normal pulse width of the driving pulse in the normal hand movement mode.

The hand position control device according to the embodiment of the invention includes a rotor 202 that is rotated by the driving pulse, a hand 40 for displaying time, and a train wheel 30 that transmits rotational force of the rotor to the hand 40, and in which the control unit may set the manual pulse width of a magnitude that the rotor is subjected to magnetic braking by a driving pulse according to the manual pulse width, and the hand and the train wheel may be configured to be loads subjected to magnetic braking by the set manual pulse width.

In the hand position control device according to the embodiment of the invention, a manual pulse of the driving pulse in the manual hand position setting mode includes a first half pulse and a second half pulse, and the first half pulse may be a pulse of a predetermined duty cycle.

In the hand position control device according to the embodiment of the invention, when a rotor of the motor is rotated in a backward direction, the driving pulse includes a main driving pulse P1, a correction driving pulse P2, and a braking pulse P3 for braking rotation of the rotor, and in which when the rotor is rotated in the backward direction, the control unit may set a manual pulse width of the braking pulse in the driving pulse in the manual hand position setting mode to be larger than a normal pulse width of the braking pulse in the driving pulse in the normal hand movement mode.

Timepieces 1 and 1A according to the embodiment of the invention include any one of the hand position control devices 100 and 100A, respectively.

The timepiece according to the embodiment of the invention includes an operation unit 6 (for example, a crown 61), and in which the mode switching unit may switch between the normal hand movement mode and the manual hand position setting mode based on a result obtained by operating the operation unit by a user.

The timepiece 1A according to the embodiment of the invention includes a receiving unit 7 that receives information from a communicable device, and in which the mode switching unit may switch between the normal hand movement mode and the manual hand position setting mode based on a result obtained by receiving information transmitted from the communicable device by the receiving unit based on a result obtained by operating the communicable device by a user.

A hand position control method according to an embodiment of the invention is a hand position control method in a hand position control device 100 or 100A including a control unit 14 or 14A for setting a pulse width of a driving pulse to be output to a coil of a motor that rotates a hand, and includes a step (S3 or S6) of allowing a mode switching unit 13 or 13A to switch between a normal hand movement mode and a manual hand position setting mode and a step (step S5) of allowing the control unit to set a manual pulse width of the driving pulse in the manual hand position setting mode to be larger than a normal pulse width of the driving pulse in the normal hand movement mode at the time of the manual hand position setting mode.

### BRIEF DESCRIPTION OF THE DRAWINGS

FIG. 1 is a block diagram illustrating a configuration example of a timepiece according to the present embodiment.

FIG. 2 is a diagram illustrating an appearance example of the timepiece according to the embodiment.

FIG. 3 is a diagram illustrating a configuration example of a motor according to the embodiment.

FIG. 4 is a plan view illustrating a configuration example of a train wheel according to the embodiment.

FIG. 5 is a diagram illustrating an example of a driving pulse waveform during forward rotation according to the embodiment.

FIG. 6 is a diagram for explaining a relationship between a main driving pulse and a motor in a normal hand movement mode according to the embodiment.

FIG. 7 is a diagram illustrating the main driving pulse and a state of the motor in the normal hand movement mode according to the embodiment.

FIG. 8 is a diagram for explaining a relationship between a main driving pulse and a motor in a manual hand position setting mode according to the embodiment.

FIG. 9 is a diagram illustrating the main driving pulse and a state of the motor in the manual hand position setting mode according to the embodiment.

FIG. 10 is a diagram illustrating an example of driving pulses during backward rotation according to the embodiment.

FIG. 11 is a flowchart illustrating an example of a processing procedure performed by the timepiece according to the embodiment.

FIG. 12 is a block diagram illustrating a configuration example of a timepiece according to a modification example of the embodiment.

FIG. 13 is a diagram illustrating an example of an image displayed on a display unit of a portable terminal according to the embodiment.

### DETAILED DESCRIPTION OF THE PREFERRED EMBODIMENTS

Hereinafter, embodiments of the invention will be described with reference to the drawings. In the drawings used for the following description, in order to make each member recognizable size, the scale of each member is appropriately changed.

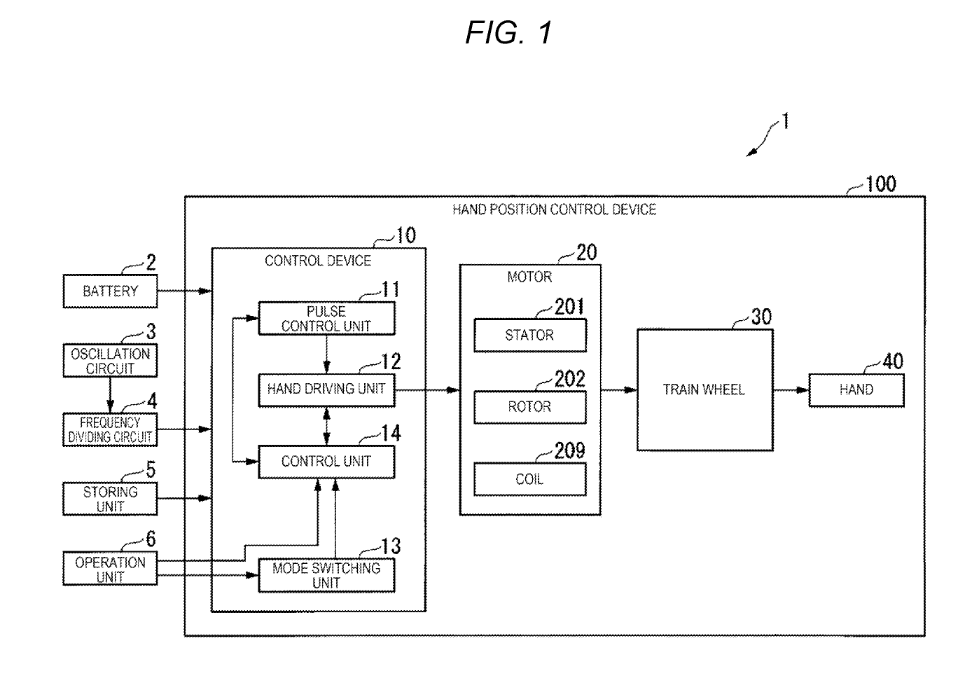

FIG. 1 is a block diagram illustrating a configuration example of a timepiece 1 according to the embodiment. As illustrated in FIG. 1, the timepiece 1 includes a battery 2, an oscillation circuit 3, a frequency dividing circuit 4, a storing unit 5, an operation unit 6, and a hand position control device 100. The hand position control device 100 includes a control device 10, a motor 20, a train wheel 30, and a hand 40. The control device 10 includes a pulse control unit 11, a hand driving unit 12, a mode switching unit 13, and a control unit 14. The motor 20 is configured to include a stator 201, a rotor 202, and a coil 209.

The timepiece 1 illustrated in FIG. 1 is an analog timepiece for displaying the clocked time with the hand 40. In the example illustrated in FIG. 1, for simplicity of description, one hand 40 is provided, but the number of hands 40 may be two or more. In that case, the timepiece 1 is provided with the hand driving unit 12, the motor 20, and the train wheel 30 for each hand 40.

The battery 2 is, for example, a lithium battery or a silver oxide battery, and is a so-called button battery. The battery 2 may be a solar battery and a storage battery that stores power generated by the solar battery. The battery 2 supplies electric power to the control device 10.

The oscillation circuit 3 is a passive element used to oscillate a predetermined frequency from mechanical resonance by utilizing a piezoelectric phenomenon of quartz, for example. Here, the predetermined frequency is, for example, 32 [kHz].

The frequency dividing circuit 4 divides a signal of the predetermined frequency output from the oscillation circuit 3 into a desired frequency and outputs the frequency-divided signal to the control device 10.

The storing unit 5 stores driving pulses used in a normal hand movement mode. The storing unit 5 stores driving pulses used in a manual hand position setting mode. The normal hand movement mode is, for example, an operation mode for displaying the time. The manual hand position setting mode is an operation mode in which the hand is rotated one step at a time according to a user's instruction. In the embodiment, the manual hand position setting mode is also referred to as zero match. Such a zero match is performed in a case where, for example, an initial position of the hand 40 is deviated due to the influence shocked to the timepiece 1 and a function of matching the position of the hand 40 of the timepiece 1 with a reference position (for example, the position of 12 o'clock) is not properly operated. The function of matching the position of the hand 40 with the reference position (for example, the position of 12 o'clock) is performed, for example, when the battery 2 is exchanged and reset, when the user operates an operation unit 6 to select processing for the operation, or the like.

The operation unit 6 is, for example, a crown, a push button, a touch panel, or the like. The operation unit 6 detects the result of the operation by the user and outputs the detected operation result to the mode switching unit 13 and the control unit 14.

In the normal hand movement mode, the control device 10 drives the motor 20 using a driving pulse of the normal hand movement mode stored in the storing unit 5 to move the hand 40 through the train wheel 30. In the manual hand position setting mode, the control device 10 drives the motor 20 using the driving pulse in the manual hand position setting mode stored in the storing unit 5 to move the hand 40 through the train wheel 30.

In the normal hand movement mode, the pulse control unit 11 performs clocking using a signal of a desired frequency divided by the frequency dividing circuit 4, generates a pulse signal so as to move the hand 40 using the driving pulse of the normal hand movement mode according to the clocked result, and outputs the generated pulse signal to the hand driving unit 12. In the manual hand position setting mode, the pulse control unit 11 generates a pulse signal so as to move the hand 40 using a signal of a desired frequency divided by the frequency dividing circuit 4 and the driving pulse of the manual hand positioning setting mode, and outputs the generated pulse signal to the hand driving unit 12.

The hand driving unit 12 generates a pulse signal for rotating the motor 20 forward or backward according to control of the pulse control unit 11. In the normal hand movement, the hand driving unit 12 drives the motor 20 at each predetermined period by the generated pulse signal (driving pulse) mode. In the manual hand position setting mode, the hand driving unit 12 drives the motor 20 for each operation result output by the operation unit 6 by the generated pulse signal (driving pulse).

The mode switching unit 13 switches from the normal hand movement mode to the manual hand position setting mode, or switches from the manual hand position setting mode to the normal hand movement mode based on the operation result output by the operation unit 6, and outputs mode information indicating the switched mode to the control unit 14. The mode information includes information indicating the normal hand movement mode or information indicating the manual hand position setting mode.

In a case where the mode information output by the mode switching unit 13 is information indicating the normal hand movement mode, the control unit 14 outputs an instruction to the pulse control unit 11 to drive the hand 40 with the driving pulse of the normal hand movement mode. In a case where the mode information output by the mode switching unit 13 is information indicating the manual hand position setting mode, the control unit 14 outputs an instruction to the pulse control unit 11 to drive the hand 40 with the driving pulse of the manual hand position setting mode. In the driving pulse in the manual hand position setting mode, an excitation section is longer than that of the driving pulse in the normal hand movement mode. The driving pulse will be described later. The control unit 14 drives the motor 20 so as to rotate forward or reverse one step at a time according to the operation result output from the operation unit 6.

The motor 20 is, for example, a stepping motor. The motor 20 drives the hand 40 through the train wheel 30 by the pulse signal output by the hand driving unit 12.

The train wheel 30 is configured to include at least one wheel gear.

The hand 40 is, for example, an hour hand, a minute hand, a second hand, or the like. The hand 40 is rotatably supported by a support (not illustrated).

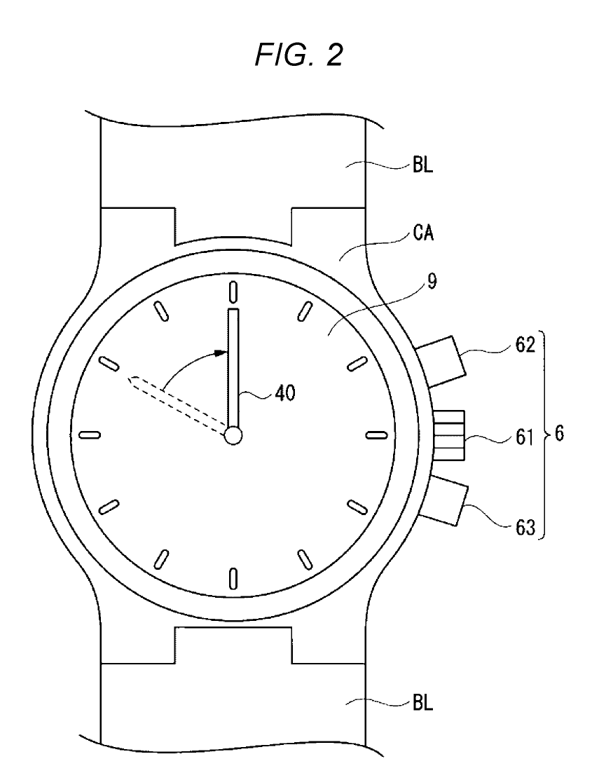

FIG. 2 is a diagram illustrating an appearance example of the timepiece 1 according to the embodiment.

As illustrated in FIG. 2, the timepiece 1 further includes a case CA, a dial 9, and a band BA. In the example illustrated in FIG. 2, the operation unit 6 includes a crown 61, a push button 62, and a push button 63.

When performing a zero match operation, the user operates, for example, the crown 61 to perform an operation of switching from the normal hand movement mode to the manual hand position setting mode. Thereafter, the user operates so as to push the push button 62 to advance the hand 40 one step at a time. Alternatively, the user operates the push button 63 so as to return the hand 40 one step at a time. In response to this operation, the timepiece 1 rotates the hand 40 in a forward direction one step at a time from the 10 o'clock position to the 12 o'clock position as illustrated by the arrow. In the example illustrated in FIG. 2, the user pushes the push button 62 ten times so as to advance the hand. Then, the timepiece 1 causes the hand 40 to rotate forward for a total of 10 steps.

### Configuration Example and Operation Example of Motor 20

Next, a configuration example and an operation example of the motor 20 will be described.

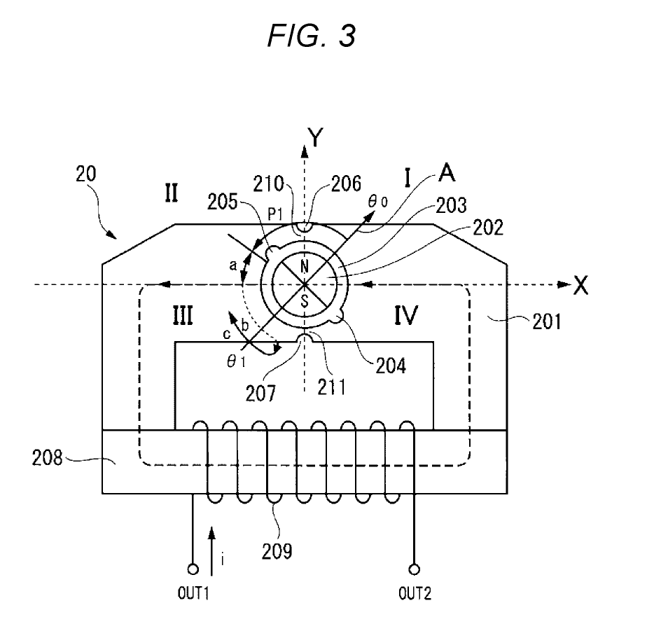

FIG. 3 is a diagram illustrating a configuration example of the motor 20 according to the embodiment.

In a case where the motor 20 is used for an analog electronic timepiece, the stator 201 and a coil core 208 are fixed to a main plate (not illustrated) by screws (not illustrated) and are joined to each other. The coil 209 has a first terminal OUT1 and a second terminal OUT2.

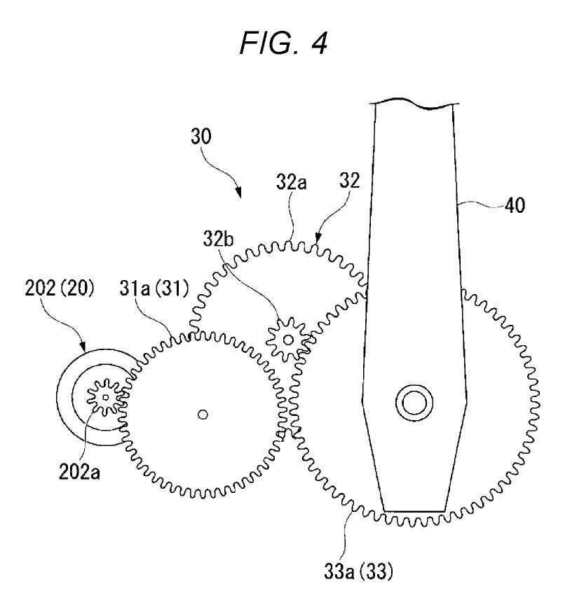

The rotor 202 is magnetized to have two poles (S pole and N pole). A pinion 202a (see FIG. 4) is provided on the rotor 202. A plurality of (two in the embodiment) cutout portions (outer notches) 206 and 207 are provided at positions facing each other across a rotor accommodating through-hole 203 at the outer end portion of the stator 201 formed of a magnetic material. Saturable portions 210 and 211 are provided between the outer notches 206 and 207 and the rotor accommodating through-hole 203.

The saturable portions 210 and 211 are configured not to be magnetically saturated by the magnetic flux of the rotor 202 and to be magnetically saturated when the coil 209 is excited to increase the magnetic resistance. The rotor accommodating through-hole 203 is formed in a circular hole shape in which a plurality (two in the embodiment) of semilunar cutout portions (inner notches) 204 and 205 are integrally formed in facing portions of through-holes having a circular contour.

The cutout portions 204 and 205 constitute a positioning portion for determining the stop position of the rotor 202. In a state where the coil 209 is not excited, the rotor 202 stably stops at a position corresponding to the positioning portion as illustrated in FIG. 3, in other words, a position (angle θ₀ position) where a magnetic pole axis A of the rotor 202 is orthogonal to a line segment connecting the cutout portions 204 and 205. An XY-coordinate space centered on the rotation axis (rotation center) of the rotor 202 is divided into four quadrants (first quadrant I to fourth quadrant IV).

In FIG. 3, reference numerals a, b, and c are rotation regions of the rotor 202, respectively.

Here, when a main driving pulse of a rectangular wave is supplied to the first terminal OUT1 and the second terminal OUT2 from the hand driving unit 12 (for example, the first terminal OUT1 side is a positive polarity and the second terminal OUT2 side is a negative polarity) and a driving current i flows in the direction of the arrow in FIG. 3, a magnetic flux is generated in the stator 201 in the direction of the broken line arrow. With this configuration, the saturable portions 210 and 211 are saturated and the magnetic resistance is increased. Thereafter, by interaction between the magnetic poles generated in the stator 201 and the magnetic poles of the rotor 202, the rotor 202 is rotated by 180 degrees in the direction of the arrow in FIG. 3 and the magnetic pole axis stops stably at the angle θ₁ position. A rotation direction (counterclockwise direction in FIG. 3) for causing the stepping motor 107 to rotate to perform a normal operation (hand movement operation because the timepiece is an analog electronic timepiece in the embodiment) is defined as a forward direction and a direction (clockwise direction) opposite to the forward direction is defined as a reward direction.

Here, when a main driving pulse of a rectangular wave in an opposite polarity is supplied to the first terminal OUT1 and the second terminal OUT2 of the coil 209 (first terminal OUT1 side is a negative pole and the second terminal OUT2 side is a positive pole so as to have a polarity opposite to that of the driving) from the hand driving unit 12 and the driving current i flows in the direction of the anti-arrow in FIG. 3, a magnetic flux is generated in the stator 201 in the direction of the anti-broken line arrow. With this configuration, the saturable portions 210 and 211 are saturated first, and then the rotor 202 is rotated by 180 degrees in the same direction (positive direction) as described above by the interaction between the magnetic poles generated in the stator 201 and the magnetic poles of the rotor 202 and the magnetic pole axis stops stably at the angle θ₀ position.

Thereafter, as described above, the hand driving unit 12 supplies signals (alternating signals) having different polarities to the coil 209. With this configuration, the motor 20 is configured such that the operation described above is repeatedly performed and thus, the rotor 202 can be continuously rotated by 180 degrees in the direction of the arrow.

The hand driving unit 12 (FIG. 1) rotationally drives the motor 20 by alternately driving the motor 20 with driving pulses P1 having different polarities from each other, and in a case where when it is not possible to rotationally drive the motor 20 by the main driving pulse P1, the hand driving unit 12 rotationally drives the motor 20 using the correction driving pulse P2 having the same polarity as the main driving pulse P1.

FIG. 4 is a plan view illustrating a configuration example of the train wheel 30 according to the embodiment.

As illustrated in FIG. 4, the train wheel 30 includes a first intermediate wheel 31, a second intermediate wheel 32, and a hand wheel 33. The first intermediate wheel 31 includes a first intermediate wheel gear 31a and a first intermediate pinion (not illustrated). The first intermediate wheel gear 31a meshes with a pinion 202a of the rotor 202 of the motor 20. The second intermediate wheel 32 includes a second intermediate wheel gear 32a and a second intermediate pinion 32b (second wheel gear). The second intermediate wheel gear 32a meshes with the first intermediate pinion of the first intermediate wheel 31. The hand wheel 33 includes a hand wheel gear 33a (first wheel gear) meshing with the second intermediate pinion 32b of the second intermediate wheel 32. The hand 40 is attached to the hand wheel 33.

A configuration of the train wheel 30 illustrated in FIG. 4 is an example, and the configuration and the number of teeth of the wheel gear are not limited thereto.

### Example of Driving Pulse During Forward Rotation

Next, an example of a driving pulse waveform during forward rotation will be described.

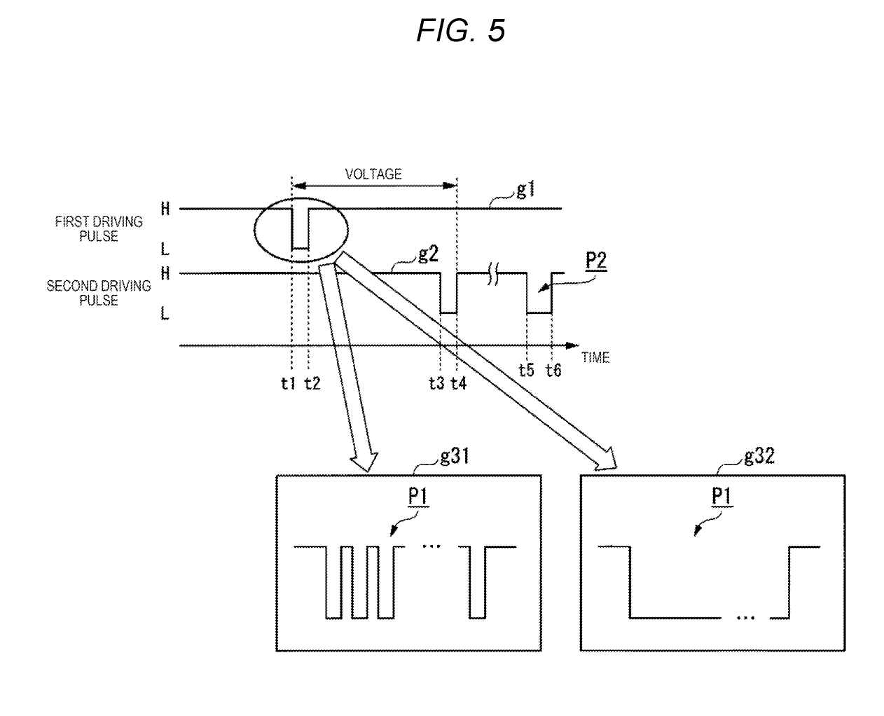

FIG. 5 is a diagram illustrating an example of a driving pulse waveform during forward rotation according to the embodiment.

In FIG. 5, the horizontal axis represents the time and the vertical axis represents whether the signal is H (high) level or L (low) level. A waveform g1 is, for example, a waveform of a first driving pulse applied to the first terminal OUT1 of the motor 20. A waveform g2 is, for example, a waveform of a second driving pulse applied to the second terminal OUT2 of the motor 20.

A period from time t1 to time t6 is a period during which the motor 20 is forwardly rotated. During a period from time t1 to time t2, the pulse control unit 11 generates a first driving pulse. During a period from time t3 to t4, the pulse control unit 11 generates a second driving pulse. The driving signal in the period from time t1 to t2 or from time t3 to t4 is constituted by a plurality of pulse signals like a region indicated by a reference numeral g31, and the pulse control unit 11 adjusts the duty of the pulses. In this case, the period from time t1 to t2 or the period from time t3 to t4 changes in accordance with the pulse duty. Hereinafter, in the embodiment, a signal wave in the region indicated by a reference numeral g31 is referred to as a “comb tooth wave”. The driving signal in the period from time t1 to t2 or from time t3 to t4 is constituted by one pulse signal like a region indicated by a reference numeral g32, and the pulse control unit 11 adjusts the pulse width. In this case, the period from time t1 to t2 or the period from time t3 to t4 changes according to the pulse width. Hereinafter, in the embodiment, a signal wave in the region indicated by the reference numeral g32 is referred to as a “rectangular wave”.

In the embodiment, the pulse in the period from time t1 to t2 or from time t3 to t4 is referred to as the main driving pulse P1.

The correction driving pulse P2 in the period from time t5 to the time t6 is a driving pulse output only when it is detected that the rotor is not rotated by the main driving pulse P1.

### Normal Hand Movement Mode

First, the driving pulse and the behavior of the motor 20 in the normal hand movement mode will be described.

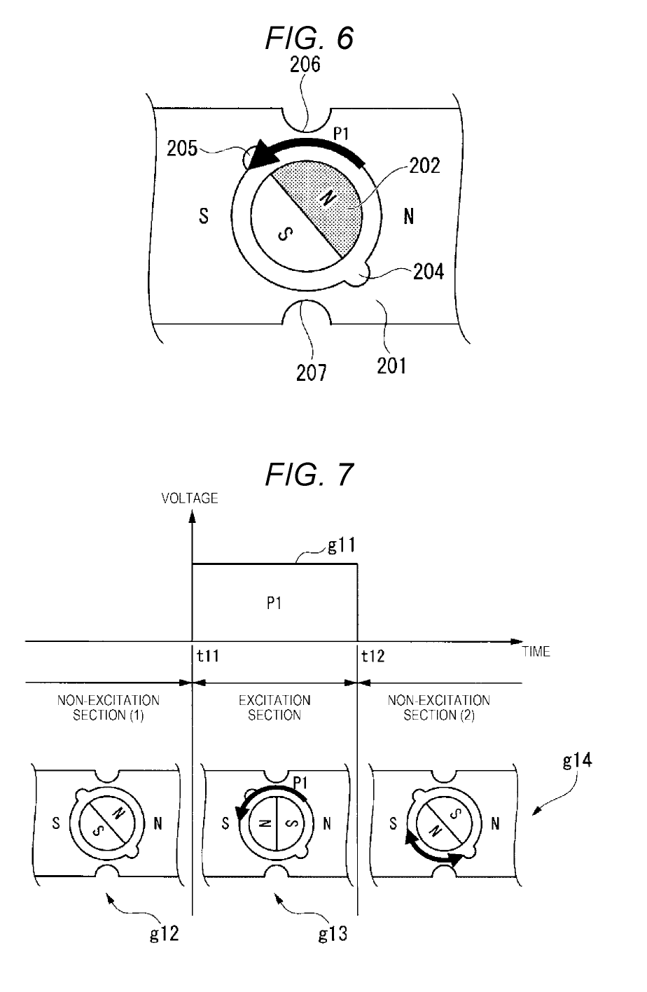

FIG. 6 is a diagram for explaining a relationship between the main driving pulse P1 and the motor 20 in the normal hand movement mode according to the embodiment.

In the normal hand movement mode, if the main driving pulse P1 gives driving energy so that the rotor 202 rotates up to the cutout portion 205, then the rotor 202 overruns, further freely vibrates, and stops at a desired stop position (180 degrees) by suction force.

FIG. 7 is a diagram illustrating the main driving pulse P1 and the state of the motor 20 in the normal hand movement mode according to the embodiment. In FIG. 7, a reference numeral g11 indicates a driving pulse. The reference numerals g12 to g14 represent a state of the motor 20. In the reference numeral g11, the horizontal axis represents time [msec] and the vertical axis represents voltage [V]. In FIG. 7, the driving pulse is indicated by a “rectangular wave”, but the driving pulse may be a “comb tooth wave”.

A section up to time t11 is a non-excitation section (1). During this section, no driving pulse is applied to the motor 20. For that reason, as indicated by the reference numeral g12, the rotor 202 is stopped.

A section between time t11 and time t12 is an excitation section. During this section, the main driving pulse P1 is applied to the motor 20. With this configuration, the rotor 202 rotates beyond the cutout portion 205, as indicated by the reference numeral g13. The application section of the main driving pulse P1 at the time t11 to t12 in the normal hand movement mode is, for example, 3 to 4 [msec].

A section after time t12 is the non-excitation section (2). During this section, a driving pulse is not applied to the motor 20. The rotor 202 overruns and freely oscillates as indicated by the reference numeral g14 by kinetic energy accelerated in the excitation section and then stops at a desired stop position. As such, in a case where vibration of the rotor 202 in the non-excitation section (2) is large, if the hand 40 is driven to rotate one step at a time, the train wheel 30 may be rotated too much as described above.

### Manual Hand Position Setting Mode

Next, the driving pulse and the behavior of the motor 20 in the manual hand position setting mode will be described.

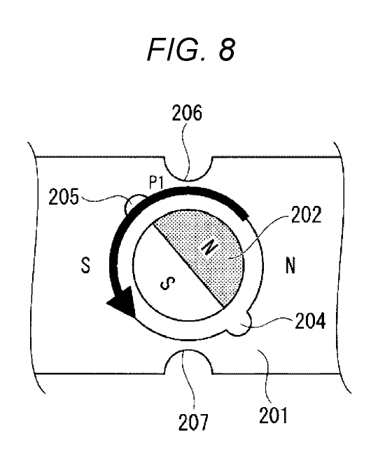

FIG. 8 is a diagram for explaining the relationship between the main driving pulse P1 and the motor 20 in the manual hand position setting mode according to the embodiment.

In the manual hand position setting mode, the main driving pulse P1 gives driving energy so that the rotor 202 rotates beyond the cutout portion 205. In this case, the driving energy is continuously applied to the rotor 202 even in a region after reaching the horizontal magnetic pole.

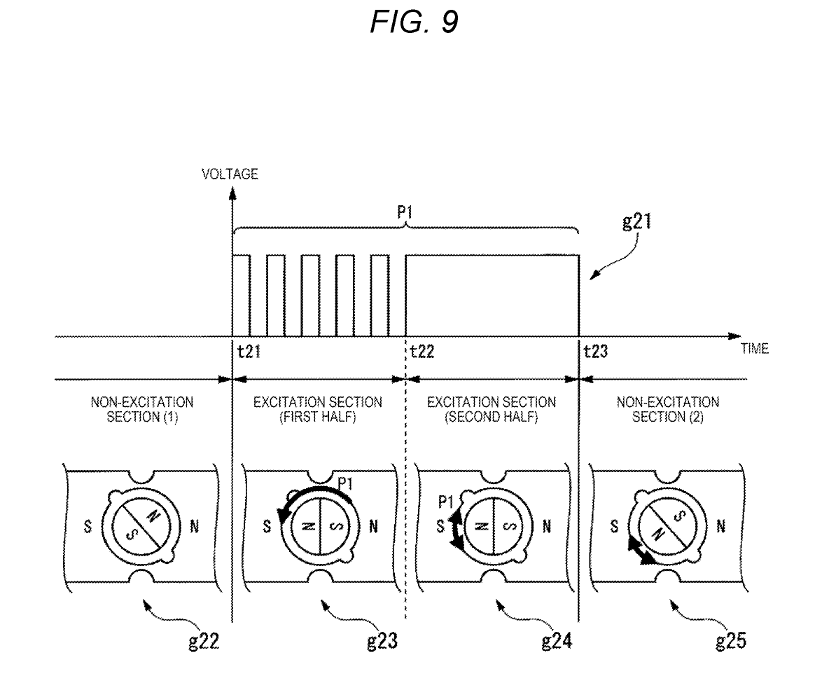

FIG. 9 is a diagram illustrating the main driving pulse P1 and the state of the motor 20 in the manual hand position setting mode according to the embodiment. In FIG. 9, the reference numeral g21 indicates a driving pulse. The reference numerals g22 to g25 represent the states of the motor 20. In the graph indicated by the reference g21, the horizontal axis represents the time [msec] and the vertical axis represents the voltage [V].

A section up to time t21 is a non-excitation section (1). During this section, no driving pulse is applied to the motor 20. For that reason, as indicated by the reference numeral g22, the rotor 202 is stopped.

A section between time t21 and time t23 is the excitation section. During this section, the main driving pulse P1 is applied to the motor 20. As illustrated in FIG. 9, the main driving pulse P1 in the manual hand position setting mode is divided into a main driving pulse in an excitation section (first half) and another main driving pulse in another excitation section (second half). Here, the driving pulse in the excitation section (first half) is referred to as a first half pulse. Also, the driving pulse in the excitation section (second half) is referred to as a second half pulse.

A section between time t21 to time t22 is set as the excitation section (first half), and the section between time t22 and the t23 is set as the excitation section (second half). An application section of the main driving pulse P1 between time t21 and time t23 in the manual hand position setting mode is, for example, 8 [msec]. In the example illustrated in FIG. 9, the excitation section (first half) is, for example, “comb tooth wave” with duty 50% and the excitation section (second half) is an example of a “rectangular tooth”. As such, the driving energy of the excitation section (first half) is made smaller than the excitation section (second half) so as to make it possible to prevent the rotor 202 from rotating excessively.

In the excitation section (first half) between time t21 and time t22 as indicated by the reference numeral g23, the rotor 202 exceeds the horizontal magnetic pole due to the first half of the applied main driving pulse P1. The section between time t21 and time t22 is, for example, 3 to 4 [msec]. The H level period and the L level period are, for example, 1 [msec], respectively.

In the excitation section (second half) between time t22 and time t23 as indicated by the reference numeral g24, the rotor 202 exceeds the horizontal magnetic pole by the second half portion of the applied main driving pulse P1, and the rotor 202 is vibrated by driving energy. Kinetic energy is consumed by vibration of the rotor 202. The section between time t22 and t23 is, for example, 4 to 5 [msec] (that is, 8-(3 to 4) [msec]).

As a result, after time t23, vibration of the rotor 202 in the non-excitation section (2) becomes smaller than that in the non-excitation section (2) of the normal hand movement mode (see reference numeral g14 in FIG. 7) as indicated by the reference numeral g25.

As such, in the manual hand position setting mode, since the vibration of the rotor 202 in the non-excitation section (2) is made smaller than that in the normal hand movement mode, when the hand 40 is driven to rotate one step at a time, it is possible to prevent the train wheel 30 from rotating excessively.

The waveform of the driving pulse illustrated in FIG. 9 is an example, but is not limited thereto. The duty of the driving pulses may be set depending on the characteristics of the motor 20, the load of the train wheel 30 and the hand 40, and the like. For that reason, the excitation section (second half) may also be a “comb tooth wave”. In contrast, the excitation section (first half) may be a “rectangular tooth” depending on the load.

In the embodiment, in the driving pulse of the normal hand movement mode described above, a portion from time t11 to time t12 in FIG. 7 is referred to as a pulse width, and in the driving pulse in the manual hand position setting mode, a portion from the time t21 to time t23 in FIG. 9 is referred to as a pulse width. That is, in the embodiment, during forward rotation, a manual pulse width of the driving pulse in the manual hand position setting mode is larger than a normal pulse width of the driving pulse in the normal hand movement mode.

### Driving Pulse During Backward Rotation

Next, an example of driving pulses during backward rotation will be described with reference to FIG. 3.

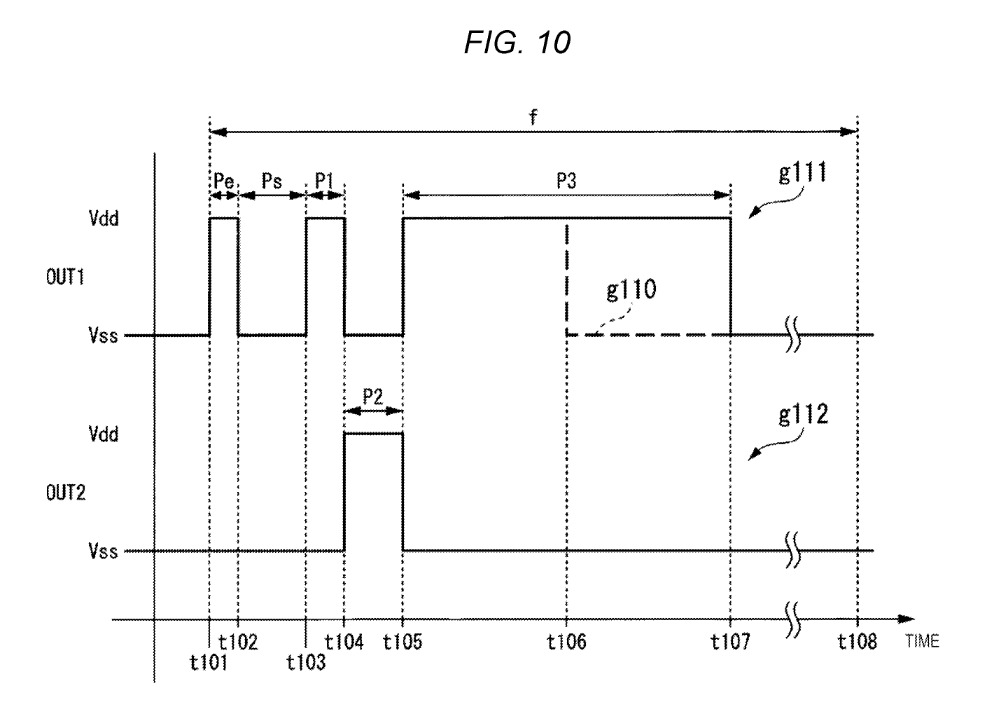

FIG. 10 is a diagram illustrating an example of a driving pulse during backward rotation according to the embodiment. In FIG. 10, waveforms g111 and g112 are driving pulse waveforms in the case of backward rotation in the motor 20 having an integrated stator. In FIG. 10, the horizontal axis represents time [msec] and the vertical axis represents voltage [V]. Vdd is, for example, a power supply voltage of a drive circuit for driving the motor 20, and Vss is 0 V or a reference voltage.

As in the waveforms g111 and g112, as a driving pulse of the stepping motor having the integral stator, a driving pulse having a width Pe is input to the first terminal OUT1 of the coil 209 in order to cancel residual magnetic flux remaining in a narrow portion of the stator 201 in the previous driving in the period from time t101 to time t102. In the period from time t103 to time t104 after the predetermined period Ps from time t102, the driving pulse having a width P1 is input to the first terminal OUT1, thereby driving the rotor 202 to slightly move in the forward direction. The period Ps is a standby period during which the rotor 202 returns to its original position after inputting the driving pulse of the period Pe. Thereafter, in a period from time t104 to the time t105, the driving pulse having the width P2 is input to the second terminal OUT2 of the coil 209, thereby driving the rotor 202 to slightly move in the backward direction.

Thereafter, for example, in the case of backward rotation in fast-forward or the like, a driving pulse (braking pulse) having a width P3 is input to the first terminal OUT1 for a period from time t105 to time t106 as indicated by the reference numeral g110, thereby driving the rotor 202 to move in the backward direction.

On the other hand, in the embodiment, in the case of backward rotation in the manual hand position setting mode, in the period from time t105 to time t107, the driving pulse having the width P3 is input to the first terminal OUT1, thereby driving the rotor 202 to move in the backward direction. As such, in the driving pulse during the backward rotation in the manual hand position setting mode, a length of the driving pulse P3 is made longer than that in the case of fast-forward or the like.

That is, in the embodiment, during the backward rotation, the length of the driving pulse P3 in the manual hand position setting mode is made larger than that in the normal hand movement mode.

In a case where if the driving pulse having the width Pe is not input to the first terminal OUT1 but the rotor 202 starts to move from input of the driving pulse having the width P1 at time t103, since the residual magnetic flux remains, the operation of the rotor 202 becomes unstable. As such, in the stepping motor having a general integrated stator, during the backward rotation, the period of the driving pulse having the width Pe for canceling the residual magnetic flux and the period Ps which is the standby period is necessary during a frame f (time t101 to time t108), which is a period for moving the hand for one step. However, in a case where the stator is a two-piece type stator or has a sufficient resting period for rotor behavior, the Pe driving pulse can be omitted.

In the embodiment, in the drive pulse of the normal hand movement mode described above, a period from the time t105 to time t106 in FIG. 10 is referred to as a pulse width, and in the drive pulse in the manual hand position setting mode, another period from the time t105 to time t107 in FIG. 10 is referred to as another pulse width. That is, in the embodiment, even in the backward rotation, the manual pulse width of the drive pulse in the manual hand position setting mode is larger than the normal pulse width of the drive pulse in the normal hand movement mode.

Next, a processing example performed by the timepiece 1 will be described.

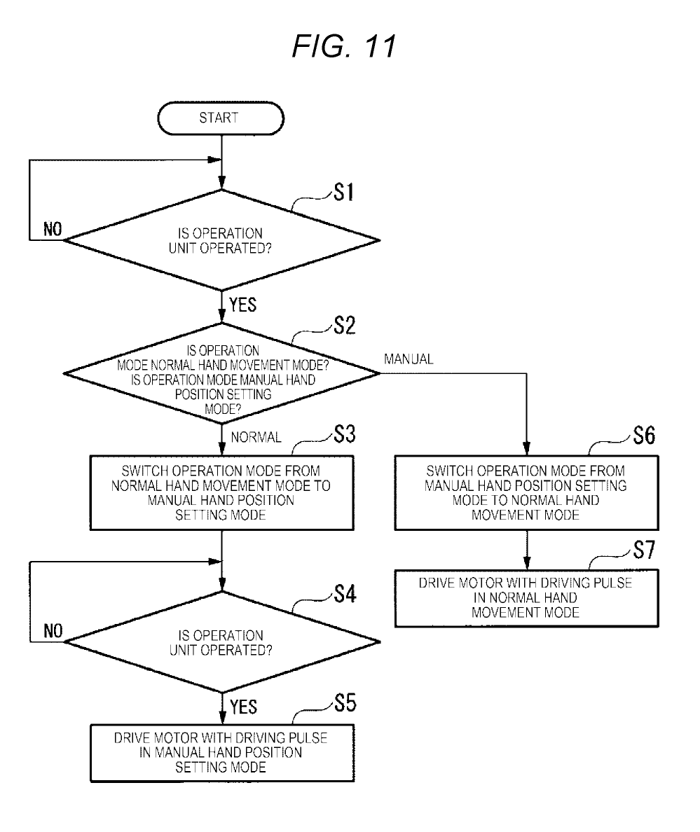

FIG. 11 is a flowchart illustrating an example of a processing procedure performed by the timepiece 1 according to the embodiment.

(Step S1) The operation unit 6 detects whether or not an operation is performed by the user. When the operation unit 6 detects that the operation is performed (YES in step S1), the operation unit 6 proceeds to processing of step S2. When the operation unit 6 cannot detect that the operation is performed (NO in step S1), the operation unit 6 repeats processing of step S1. The operation unit 6 in step S1 is, for example, a crown 61 (FIG. 2).

(Step S2) The mode switching unit 13 determines whether the current operation mode is the normal hand movement mode or the manual hand position setting mode. When the mode switching unit 13 determines that the current operation mode is the normal hand movement mode (Normal in Step S2), the mode switching unit 13 proceeds to processing of step S3. When the mode switching unit 13 determines that the current operation mode is the manual hand position setting mode (Manual in step S2), the mode switching unit 13 proceeds to processing of step S6.

(Step S3) The mode switching unit 13 switches the current operation mode from the normal hand movement mode to the manual hand position setting mode. After processing of step S3, the mode switching unit 13 proceeds to processing of step S4.

(Step S4) The operation unit 6 detects whether or not the operation is performed by the user. When the operation unit 6 detects that the operation is performed (YES in step S4), the operation unit 6 proceeds to processing of step S5. When the operation unit 6 cannot detect that the operation is performed (NO in step S4), the operation unit 6 repeats processing of step S4. The operation unit 6 in step S4 is, for example, the push button 62 or the push button 63 (FIG. 2).

(Step S5) The control unit 14 drives the motor 20 one step at a time with the driving pulse in the manual hand position setting mode. That is, based on information stored in the storing unit 5, the control unit 14 switches the manual pulse width of the driving pulse to be larger than the normal pulse width of the driving pulse in the normal hand movement mode, in the manual hand position setting mode.

The control unit 14 repeats processing of steps S4 and S5 until the operation unit 6 (crown 61) is operated again by the user and the operation mode is switched from the manual hand position setting mode to the normal hand movement mode.

(Step S6) The mode switching unit 13 switches the current operation mode from the manual hand position setting mode to the normal hand movement mode. After processing of step S6, the mode switching unit 13 proceeds to processing of step S7.

(Step S7) The control unit 14 drives the motor 20 with the driving pulse in the normal hand movement mode. By doing as described above, processing performed by the timepiece 1 is ended.

As described above, in the embodiment, the normal hand movement mode and the manual hand position setting mode are switched. In the embodiment, the driving pulse for driving the motor 20 is switched to a driving pulse larger than that in the normal movement mode, in the manual hand position setting mode, along with switching of the mode.

As a result, according to the embodiment, in a case where the hand position is operated by the user, it is possible for the user to ascertain the operation of the hand controlled by the drive control step according to the operation as an operation synchronized with the drive control step. With this configuration, according to the embodiment, in a case where the user instructs the operation of the hand while visually recognizing movement of the hand, the hand can be operated as intended by the user.

In the embodiment, the normal hand movement mode and the manual hand position setting mode are switched, and in the manual hand position setting mode, driving energy of the driving pulses is set to be larger than that in normal energy in the zero match. As a result, according to the embodiment, since the driving pulse in the manual hand position setting mode is not used in the normal hand movement mode, the amount of electric power consumed in the normal hand movement mode can be suppressed.

In the example described above, an example in which the timepiece 1 switches between the normal hand movement mode and the manual hand position setting mode, and switches the pulse width between the driving pulse of the normal hand movement mode and the driving pulse of the manual hand position setting mode is described, but is not limited thereto. The timepiece 1 may further have a fast-forward mode and the storing unit 5 may also store the driving pulses of the fast-forward mode. The fast-forward mode is used, for example, at time adjustment. In this case, the user operates the operation unit 6 to select the fast-forward mode. Then, the mode switching unit 13 detects the operation of the user and switches the mode to the fast-forward mode. With this configuration, the control unit 14 drives the motor 20 using the driving pulse in the fast-forward mode. The pulse width of the driving pulse in the fast-forward mode is smaller than that of the driving pulse in the manual hand position setting mode and larger than that of the driving pulse in the normal hand movement mode.

In a case where the user operates the operation unit 6 a plurality of times within a predetermined time, the control unit 14 may receive a first operation for the predetermined time (one frame) and not receive other operations. Here, the predetermined time is the time required for one step rotation of the hand 40, and in the case of forward rotation, for example, it is 15.6 [msec] when the hand 40 is driven at 64 Hz, and in the case of backward rotation, for example, it is 31.25 [msec] when the hand 40 is driven at 32 Hz. Alternatively, the operations performed the plurality of times within the predetermined time may be sequentially executed for each predetermined time (one frame).

### Modification Example

In the example described above, although the example in which the normal hand movement mode and the manual hand position setting mode are switched based on the result of the user operating the operation unit 6 of the timepiece 1 is described, switching may be made from an instruction from a portable terminal such as a smartphone or the like.

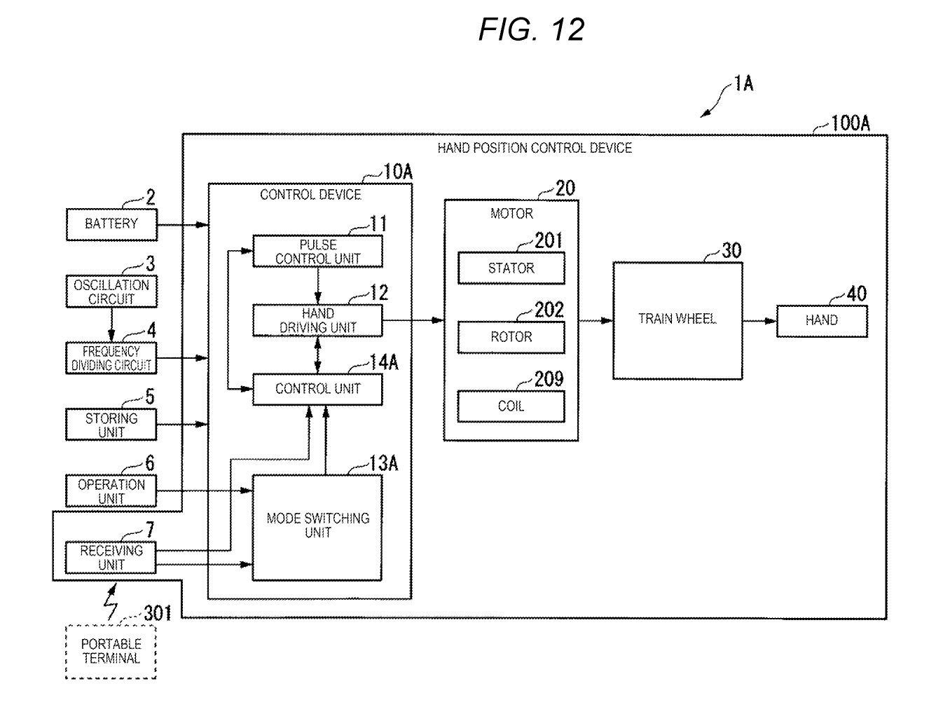

FIG. 12 is a block diagram illustrating a configuration example of a timepiece 1A according to a modification example of the embodiment. As illustrated in FIG. 12, the timepiece 1A includes the battery 2, the oscillation circuit 3, a frequency dividing circuit 4, the storing unit 5, the operation unit 6, and a hand position control device 100A. The hand position control device 100A includes a control device 10A, the motor 20, the train wheel 30, the hand 40, and the receiving unit 7. The control device 10A includes the pulse control unit 11, the hand driving unit 12, a mode switching unit 13A, and a control unit 14A. The same reference numerals are used for the functional portions having the same functions as those of the timepiece 1, and the description thereof will be omitted.

The timepiece 1A also receives information from a portable terminal 301. Communication between the timepiece 1A and the portable terminal 301 is performed by communication using a communication scheme based on Bluetooth (registered trademark) low energy (LE) (hereinafter, referred to as BLE) standard, and a Radio frequency identifier (RFID).

The portable terminal 301 is, for example, a smartphone, a tablet terminal, a portable game device, or the like. The portable terminal 301 includes a central processing unit (CPU) (not illustrated), a storing unit, a communication unit, a display unit, an operation unit, a battery, and the like.

The receiving unit 7 receives information transmitted from the portable terminal 301, extracts mode switching information from the received information, and outputs the extracted mode switching information to the mode switching unit 13A. The mode switching information is any one of information indicating a normal hand movement mode, information indicating a manual hand position setting mode, and information for switching a mode. The receiving unit 7 receives information transmitted from the portable terminal 301, extracts information for advancing the hand 40 by one step or information for returning the hand 40 by one step from the received information, and outputs the extracted information to the control unit 14A.

The mode switching unit 13A switches from the normal hand movement mode to the manual hand position setting mode or switches from the manual hand position setting mode to the normal hand movement mode based on the operation result output by the operation unit 6, and outputs mode information indicating the switched mode to the control unit 14A. Alternatively, the mode switching unit 13A switches from the normal hand movement mode to the manual hand position setting mode or from the manual hand position setting mode to the normal hand movement mode based on the mode switching information output by the receiving unit 7, and outputs mode information indicating the switched mode to the control unit 14A.

In a case where the mode information output from the mode switching unit 13A is information indicating the normal hand movement mode, the control unit 14A outputs an instruction to the pulse control unit 11 to drive the hand 40 with the driving pulse of the normal hand movement mode. In a case where the mode information output by the mode switching unit 13A is information indicating the manual hand position setting mode, the control unit 14A outputs an instruction to the pulse control unit 11 to drive the hand 40 with the driving pulse in the manual hand position setting mode. The control unit 14A drives the motor 20 to rotate forward or backward one step at a time according to information for advancing the hand 40 output by the receiving unit 7 by one step or information for returning the hand 40 by one step.

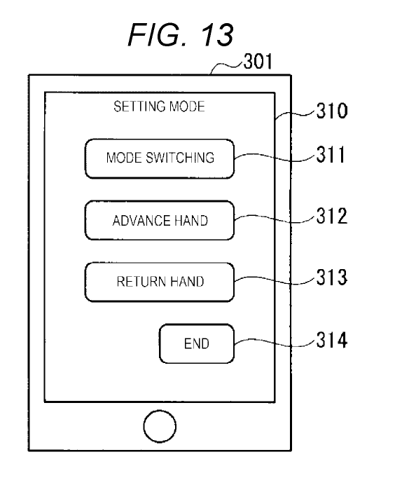

FIG. 13 is a diagram illustrating an example of an image displayed on the display unit 310 of the portable terminal 301 according to the embodiment. In the example illustrated in FIG. 13, on the display unit 310, a “Mode switching” button image 311 for switching the operation mode, an “Advance a hand” button image 312 for advancing the hand 40 by one step, a “Return a hand” button image 313 for returning the hand 40 by one step, and an “End” button image 314 for ending the operation are displayed.

When the user desires to perform the zero match operation, the user first touches the “Mode switching” button image 311. The mode switching unit 13A switches from the normal hand movement mode to the manual hand position setting mode based on information received from the portable terminal 301. Thereafter, while visually recognizing movement of the hand 40 of the timepiece 1A, the user touches the “Advance a hand” button image 312 so as to advance the hand 40 one step at a time, for example. Based on the information received from the portable terminal 301, the control unit 14A drives the motor 20 so as to advance the hand 40 one step at a time by using the driving pulse in the manual hand position setting mode.

Since the timepiece 1A receives information from the portable terminal 301 by communication, there is a case that a time difference occurs between the time when the user operates the portable terminal 301 and the time when the hand 40 of the timepiece 1A rotates. As such, when a time difference occurs due to communication or the like, the user may recognize that the operation is not received and further operate the button image on the display unit 310 in some cases. For that reason, the control unit of the portable terminal 301 may display an image (for example, an image with a button pressed) indicating that the button image cannot be touched for a predetermined time after the button image on the display unit 310 is once touched. The control unit 14A of the timepiece 1A may receive the first operation for a predetermined time (one frame) and not receive other operations. Here, the predetermined time is the time taken for forward rotation or backward rotation of the hand 40.

As described above, according to the modification example, a user who uses a smartphone or the like operates the portable terminal 301 so as to make it possible to perform a zero match on the hand of the timepiece 1A. In this case, it is possible for the user to ascertain the operation of the hand controlled by a driving control step according to this operation as the operation synchronized with the driving control step by the user. With this configuration, even in the modification example, in a case where the user instructs the operation of the hand while visually recognizing the movement of the hand, the hand can be operated as intended by the user.

The timepiece 1A in the modification example described above may be a smartwatch. In the case of the timepiece 1A being a smartwatch, the hand 40 is not limited to display of the clocked result, but may display the remaining amount of the battery, information indicating that the portable terminal 301 received email, or information indicating that there was an incoming call, or the like. In the case of the timepiece 1A being the smartwatch, the reference position is not limited to the 12 o'clock position but may be a position according to the application.

A program for realizing all or some of the functions of the hand position control device 100 or 100A in the invention may be recorded in a computer-readable recording medium to perform all or some of processing to be performed by the hand position control device 100 or 100A by causing a computer system to read and execute the program recorded on the computer-readable recording medium. The “computer system” referred to here includes an OS and hardware such as peripheral devices. The “computer system” also includes a WWW system having a website providing environment (or display environment). The “computer-readable recording medium” refers to a storage medium a portable medium such as a flexible disk, a magneto-optical disk, a ROM, and a CD-ROM, or a hard disk built in a computer system, and the like. Furthermore, the “computer-readable recording medium” includes those holding a program for a certain period of time such as a volatile memory (RAM) inside a computer system serving as a server or a client in a case where the program is transmitted through a network such as the Internet or a communication line such as a telephone line.

The program described above may be transmitted from a computer system in which the program is stored in a storage device or the like to another computer system through a transmission medium or by a transmission wave in a transmission medium. Here, the “transmission medium” for transmitting a program refers to a medium having a function of transmitting information, such as a network (communication network) such as the Internet and a communication channel (communication line) such as a telephone line. The program described above may be for realizing some of the functions described above. Furthermore, the program may be a so-called difference file (differential program) which can realize the functions described above by a combination with a program already recorded in the computer system.

Although the embodiment for embodying the invention has been described above using the embodiment, the invention is not limited to the embodiment at all, and various modifications and substitutions can be made within the scope not departing from the gist of the invention.

What is claimed is:

1. A hand position control device comprising:
a mode switching unit that is capable of switching between a normal hand movement mode and a manual hand position setting mode; and
a control unit that sets a pulse width of a driving pulse to be output to a coil of a motor that rotates a hand and sets a manual pulse width of the driving pulse in the manual hand position setting mode to be larger than a normal pulse width of the driving pulse in the normal hand movement mode.

2. The hand position control device according to claim 1, further comprising:
a rotor that is rotated by the driving pulse;
a hand for displaying time; and
a train wheel that transmits rotational force of the rotor to the hand,
wherein the control unit sets the manual pulse width of a magnitude that the rotor is subjected to magnetic braking by a driving pulse according to the manual pulse width, and
the hand and the train wheel are configured to be loads which are subjected to magnetic braking by the set manual pulse width.

3. The hand position control device according to claim 1,
wherein a manual pulse of the driving pulse in the manual hand position setting mode includes a first half pulse and a second half pulse, and
the first half pulse is a pulse of a predetermined duty cycle.

4. The hand position control device according to claim 1,
wherein when a rotor of the motor is rotated in a backward direction, the driving pulse includes a main driving pulse, a correction driving pulse, and a braking pulse for braking rotation of the rotor, and
when the rotor is rotated in the backward direction, the control unit sets a manual pulse width of the braking pulse in the driving pulse in the manual hand position setting mode to be larger than a normal pulse width of the braking pulse in the driving pulse in the normal hand movement mode.

5. A timepiece comprising:
the hand position control device according to claim 1.

6. The timepiece according to claim 5, further comprising:
an operation unit,
wherein the mode switching unit switches between the normal hand movement mode and the manual hand position setting mode based on a result obtained by operating the operation unit by a user.

7. The timepiece according to claim 5, further comprising:
a receiving unit that receives information from a communicable device,
wherein the mode switching unit switches between the normal hand movement mode and the manual hand position setting mode based on a result obtained by receiving information transmitted from the communicable device by the receiving unit based on a result obtained by operating the communicable device by a user.

8. A hand position control method in a hand position control device including a control unit for setting a pulse width of a driving pulse to be output to a coil of a motor that rotates a hand, the method comprising:
a step of allowing a mode switching unit to switch between a normal hand movement mode and a manual hand position setting mode; and
a step of allowing the control unit to set a manual pulse width of the driving pulse in the manual hand position setting mode to be larger than a normal pulse width of the driving pulse in the normal hand movement mode at the time of the manual hand position setting mode.
